(19) United States
(12) Patent Application Publication
(10) Pub. No.: US 2007/0218221 A1
(43) Pub. Date: Sep. 20, 2007

(54) Inkjet Recording Element

(76) Inventors: Gerard A. Friour, Chalon-Sur-Saone (FR); Olivier J. Poncelet, Chalon-Sur-Saone (FR)

Correspondence Address: EASTMAN KODAK COMPANY;PATENT LEGAL STAFF, 343 STATE STREET, ROCHESTER, NY, 14650-2201, US

(21) Appl. No.: 11/573,095

(22) PCT Filed: Jul. 22, 2005
(86) PCT No.: PCT/EP05/08008

§ 371 Date: Feb. 2, 2007

(30) Foreign Application Priority Data
Aug. 3, 2004 (FR) 04/08542

(51) Int. Cl. B41M 5/50

(52) U.S. Cl. 428/32.17

(57) ABSTRACT

The present invention relates to an inkjet recording element having very good stability to ozone and to light. Said recording element comprises a support and at least one ink receiving layer, said ink-receiving layer comprising at least one amorphous silica polymer having a degree of condensation between 75% and 88%. Such a polymer can be obtained by sol-gel pathway in acid catalytic conditions from silicon alcoxides.

### FIELD OF THE INVENTION

The present invention relates to an inkjet recording element.

### BACKGROUND OF THE INVENTION

Digital photography has been growing fast for several years and the general public now has access to efficient and reasonably priced digital cameras. Therefore people are seeking to be able to produce photographic prints from a simple computer and its printer, with the best possible quality.

Many printers, especially those linked to personal office automation, use the inkjet printing technique. There are two major families of inkjet printing techniques: continuous jet and drop-on-demand.

Continuous jet is the simpler system. Pressurized ink (3.10⁵ Pa) is forced to go through one or more nozzles so that the ink is transformed into a flow of droplets. In order to obtain the most regular possible sizes and spaces between drops, regular pressure pulses are sent using for example a piezoelectric crystal in contact with the ink with high frequency (up to 1 MHz) alternating current (AC) power supply. So that a message can be printed using a single nozzle, every drop must be individually controlled and directed. Electrostatic energy is used for this: an electrode is placed around the inkjet at the place where drops form. The jet is charged by induction and every drop henceforth carries a charge whose value depends on the applied voltage. The drops then pass between two deflecting plates charged with the opposite sign and then follow a given direction, the amplitude of the movement being proportional to the charge carried by each of them. To prevent other drops from reaching the paper, they are left uncharged: so, instead of going to the support they continue their path without being deflected and go directly into a container. The ink is then filtered and can be reused.

The other category of inkjet printer is drop-on-demand (DOD). This constitutes the basis of inkjet printers used in office automation. With this method, the pressure in the ink cartridge is not maintained constant but is applied when a character has to be formed. In one widespread system there is a row of 12 open nozzles, each of them being activated by a piezoelectric crystal. The ink contained in the head is given a pulse: the piezo element contracts with an electric voltage, which causes a decrease of volume, causing the expulsion of the drop by the nozzle. When the element resumes its initial shape, it pumps into the reservoir the ink necessary for new printings. The row of nozzles is thus used to generate a column matrix, so that no deflection of the drop is necessary. One variation of this system consists in replacing the piezoelectric crystals by small heating elements behind each nozzle. The drops are ejected following the forming of bubbles of solvent vapor. The volume increase enables the expulsion of the drop. Finally, there is a pulsed inkjet system in which the ink is solid at ambient temperature. The print head thus has to be heated so that the ink liquefies and it can print. This enables rapid drying on a wider range of products than conventional systems.

There now exist new “inkjet” printers capable of producing photographic images of excellent quality. However, they cannot supply good proofs if inferior quality printing paper is used. The choice of printing paper is fundamental for the quality of the obtained image. The printing paper must combine the following properties: high-quality printed image, rapid drying after printing, good dye keeping in time, smooth appearance, and high gloss.

In general, the printing paper comprises a support coated with one or more layers according to the properties required. It is possible, for example, to apply on a support a primary attachment layer, an absorbent layer, an ink dye fixing layer and a protective layer or surface layer to provide the glossiness of the recording element. The absorbent layer absorbs the liquid part of the water-based ink composition after creation of the image. Elimination of the liquid reduces the risk of ink migration at the surface. The ink dye fixing layer prevents any dye loss into the fibers of the paper base to obtain good color saturation while preventing excess ink that would encourage the increase in size of the printing dots and reduce the image quality. The absorbent layer and fixing layer can also constitute a single ink-receiving layer ensuring both functions. The protective layer is designed to ensure protection against fingerprints and the pressure marks of the printer feed rollers. The ink-receiving layer usually comprises a binder, a receiving agent and various additives. The purpose of the receiving agent is to fix the dyes in the printing paper. The best-known inorganic receivers are colloidal silica or boehmite. For example, the European Patent Applications EP-A-976,571 and EP-A-1,162,076 describe materials for inkjet printing in which the ink-receiving layer contains as inorganic receivers Ludox™ CL (colloidal silica) marketed by Grace Corporation or Dispal™ (colloidal boehmite) marketed by Sasol. However, printing papers comprising an ink-receiving layer containing such inorganic receivers can have poor image stability over time, which is demonstrated by a loss of color density.

To meet the new requirements of the market in terms of photographic quality, printing speed and color stability, it is necessary to offer a new inkjet recording element having the properties as defined above and more particularly good dye keeping properties in time, in particular shown by good stability of the printed image colors to ozone and light.

### SUMMARY OF THE INVENTION

The new inkjet recording element according to the present invention, comprises a support and at least one ink-receiving layer, and is characterized in that said ink-receiving layer comprises at least one amorphous silica polymer having a degree of condensation between 75% and 88%.

Said amorphous silica polymer can be obtained by sol-gel pathway in acid catalytic conditions from silicon alcoxides.

The inkjet recording element according to the present invention enables a printed image to be obtained having improved dye keeping in time, shown in particular by an improved stability to ozone and light of the printed image colors.

### BRIEF DESCRIPTION OF THE DRAWINGS

FIG. 1 represents the percentage of color density loss for various comparative recording elements and according to the present invention when exposed to ozone, and

FIGS. 2 to 3 represent the percentage of color density loss for various comparative recording elements and according to the present invention when exposed to light.

### DETAILED DESCRIPTION OF THE INVENTION

The inkjet recording element according to the present invention comprises firstly a support. This support is selected according to the desired use. It can be a transparent or opaque thermoplastic film, in particular a polyester base film such as polyethylene terephthalate; cellulose derivatives, such as cellulose ester, cellulose triacetate, cellulose diacetate; polyacrylates; polyimides; polyamides; polycarbonates; polystyrenes; polyolefines; polysulfones; polyetherimides; vinyl polymers such as polyvinyl chloride; and mixtures thereof. The support used in the invention can also be paper, both sides of which may be covered with a polyethylene layer. When the support comprising the paper pulp is coated on both sides with polyethylene, it is called Resin Coated Paper (RC Paper) and is marketed under various brand names. This type of support is especially preferred to constitute an inkjet recording-element. The side of the support that is used can be coated with a very thin layer of gelatin or another composition to ensure the adhesion of the first layer on the support. To improve the adhesion of the ink-receiving layer on the support, the support surface can also have been subjected to a preliminary treatment by Corona discharge before applying the ink-receiving layer.

The inkjet recording element according to the invention comprises at least one ink-receiving layer comprising at least one hydrosoluble binder. Said hydrosoluble binder can be a hydrophilic polymer such as polyvinyl alcohol, poly(vinyl pyrrolidone), gelatin, cellulose ethers, poly(oxazolines), poly(vinylacetamides), poly(vinyl acetate/vinyl alcohol) partially hydrolised, poly(acrylic acid), poly(acrylamide), sulfonated or phosphated polyesters and polystyrenes, casein, zein, albumin, chitin, dextran, pectin, derivatives of collagen, agar-agar, guar, carragheenan, tragacanth, xanthan and others. Preferably, gelatin or polyvinyl alcohol is used. The gelatin is that conventionally used in the photographic field. Such a gelatin is described in Research Disclosure, September 1994, No. 36544, part IIA. Research Disclosure is a publication of Kenneth Mason Publications Ltd., Dudley House, 12 North Street, Emsworth, Hampshire PO10 7DQ, United Kingdom. The gelatin can be obtained from SKW and the polyvinyl alcohol from Nippon Gohsei, or Air Product with the name Airvol® 130.

According to the present invention, the ink-receiving layer comprises at least one amorphous silica polymer having a degree of condensation between 75% and 88%. This silica polymer is used as a receiving agent.

The degree of condensation is defined by the following formula:

$$Degree of Condensation = {\sum }_{1}^{4} ( i * \% {Q}_{i} ) / 4$$

where Qi denotes a site Si surrounded by i oxo bridges.

Thus, the Qi units are represented thus: 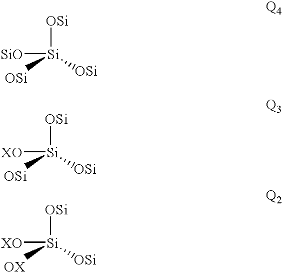
where X represents H or an R group, R being an alkyl group CₙH₂ₙ₊₁, n varying from 1 to 3.

The Qi units are determined by analysis of the RMN²⁹Si spectra, using an RMN Bruker AVANCE™300 spectrometer, equipped with a sensor CP-MAS 7 mm /Rotor: ZrO₂/MAS Rotation Speed: 4 kHz.

The ²⁹Si spectra are recorded using a pulse sequence pulse time: 4.2 μs (90°) and inter-pulse time 150 s). These conditions enable quantitative analysis of the spectra. The number of accumulations varies between 200 and 336 according to the sample. The spectra are simulated using the “WinFit” program developed by D. Massiot (“WinFit—A windows-based program for lineshapes analysis”, Massiot D., Thiele H. and Germanus A., BRUCKER Report 1994, 140, 43-46).

Preferably, said amorphous silica polymer has a degree of condensation between 75% and 87%, preferably between 75% and 86%, preferably between 80% and 86% and preferably between 84% and 86%.

According to a preferred embodiment, the amorphous silica polymer used in the present invention is obtained by sol-gel pathway in acid catalytic conditions from silicon alcoxides used as precursors.

Sol-gel synthesis is a synthesis pathway know to those skilled in the art and is for example described in the publication, “Recent progress in the study of the kinetics of sol-gel SiO₂, synthesis reactions”, Alan Mc Cormick, in Sol-Gel Processing and Applications, published by Y. A. Attia, Plenum Press, New York (1994), 3.

It results, from molecular precursors diluted in a solvent (sol creation), in the formation of a three-dimensional solid amorphous network, that is porous and filled with liquid (gel creation), by means of two chemical reactions, hydrolysis and polymerization by condensation. Thus, the use of silicon alcoxides as precursor enables an amorphous silica polymer to be formed.

The silicon alcoxide precursor has the general formula Si(OR)₄ where R is an organic alkyl group CₙH₂ₙ₊₁, with n varying from 1 to 3, and the four functions can be identical or different.

Preferably, tetraethyl orthosilicate is used as precursor.

The solvents used in the sol-gel synthesis are water, ethanol, methanol, dioxane or tetrahydrofurane.

Preferably, water and ethanol are used with the tetraethyl orthosilicate precursor. Once the tetraethyl orthosilicate and water are mixed in ethanol, the hydrolysis reaction starts and results in the formation of Si—OH silanol groups. The particles obtained in this way constitute the sol. Thanks to a chemical reaction of polymerization by condensation, these particles aggregate and form interconnected Si—O—Si links, resulting in the formation of a gel.

To obtain a polymer that can be used according to the invention, the sol-gel pathway synthesis must occur in acid catalytic conditions. The acid can comprise a solution of monovalent mineral or organic acid; the selected acid can be hydrochloric acid, perchloric acid or nitric acid.

After the initial polymerization in acid catalytic conditions, it is possible to produce gelation in basic conditions to neutralize the acid catalyst by adding ammonium hydroxide for example. Preferably, the amount of base is such that the acid catalyst is not fully neutralized. Thus, the acid catalyst can be neutralized up to 91%.

After gelation, the polymer is dried to clear the solvent out of the polymer network. In this way a dry gel or xerogel is obtained.

A preparation method for an amorphous silica polymer by the solgel pathway in acid catalytic conditions with partial acid neutralization is described in the publication, Sasaki, D. Y.; Alam, T. M. American Chemical Society 2000,12, 1400-1407.

The ink-receiving layer comprises between 5% and 95% by weight of amorphous silica polymer compared with the total weight of the dry state ink-receiving layer.

The composition of the coating intended to form the ink-receiving layer is produced by mixing the hydrosoluble binder and the silica polymer. The composition can also comprise a surfactant to improve its coating properties. The composition can be layered on the support according to any appropriate coating method, such as blade, knife or curtain coating. The composition is applied with a thickness between approximately 100 μm and 300 μm in the wet state. The composition forming the ink-receiving layer can be applied to both sides of the support. It is also possible to provide an antistatic or anti-winding layer on the back of the support coated with the ink-receiving layer.

The inkjet recording element according to the invention can comprise, besides the ink-receiving layer described above, other layers having another function, arranged above or below said ink-receiving layer. The ink-receiving layer as well as the other layers can comprise any other additives known to those skilled in the art to improve the properties of the resulting image, such as UV ray absorbers, optical brightening agents, antioxidants, plasticizers, etc.

The inkjet recording element according to the invention has good dye keeping in time. It can be used for any type of inkjet printer as well as for all the inks developed for this technology.

The following examples illustrate the present invention without however limiting its scope.
1) Preparation of silica polymer by sol-gel pathway without acid catalysis

A silica polymer was prepared by sol-gel pathway from tetraethyl orthosilicate to obtain a xerogel with the general formula SiO₂.

39.5 g tetraethyl orthosilicate were mixed with 38.6 g ethanol and 42 g deionized water. It was stirred for 10 minutes at room temperature and then for 27 hours at 60° C. to obtain a gel. The gel was put to incubate without stirring for 16 hours at 75° C.

Then the gel was washed twice with 100 ml ethanol and then twice with 100 ml deionized water. The excess liquid was removed by filtration after each washing. The washed gel was then lyophilized to a constant weight. The resulting powder was ground. 9.7 g of white powder were obtained (polymer 1).
2) Preparation of silica polymers by sol-gel pathway in acid catalytic conditions

a) Polymer 2

A silica polymer was prepared by sol-gel pathway from tetraethyl orthosilicate to obtain a xerogel with the general formula SiO₂ with 30% acid neutralization.

39.5 g tetraethyl orthosilicate were mixed with 38.6 g ethanol, 42 g deionized water and 4.5 ml of hydrochloric acid solution 0.1M. It was stirred for 10 minutes at room temperature and then for 1.5 hours at 60° C. Then 1.35 ml of aqueous solution ammonium hydroxide 0.1M were added to the resulting solution. The mixture was put to incubate without stirring for 16 hours at 75° C. The resulting gel was then washed twice with 100 ml ethanol and then twice with 100 ml deionized water. The excess liquid was removed by filtration after each washing. The washed gel was then lyophilized to a constant weight. The resulting powder was ground. 9.7 g of white powder were obtained (polymer 2).

b) Polymer 3

A silica polymer was prepared by sol-gel pathway from tetraethyl orthosilicate to obtain a xerogel with the general formula SiO₂, with 30% acid neutralization.

39.5 g tetraethyl orthosilicate were mixed with 19.3 g ethanol, 21 g deionized water and 1 ml of hydrochloric acid solution 0.1M. It was stirred for 10 minutes at room temperature and then for 1.5 hours at 60° C. Then 0.3 ml of aqueous solution ammonium hydroxide 0.1M was added to the resulting solution. The mixture was put to incubate without stirring for 16 hours at 75° C. A gel was obtained that was then gently heated to 40° C. in a vacuum (15 mm Hg) to remove practically all the remaining ethanol. The resulting gel was then lyophilized to a constant weight. The resulting powder was ground. 13.1 g of white powder were obtained (polymer 3).

c) Polymer 4

A silica polymer was prepared by sol-gel pathway from tetraethyl orthosilicate to obtain a xerogel with the general formula SiO₂, without acid neutralization.

39.5 g tetraethyl orthosilicate were mixed with 19.3 g ethanol, 21 g deionized water and 0.5 ml of hydrochloric acid solution 0.1M. It was stirred for 10 minutes at room temperature and then for 1.5 hours at 60° C. The mixture was put to incubate without stirring for 16 hours at 75° C. A gel was obtained that was then gently heated to 40° C. in a vacuum (15 mm Hg) to remove practically all the remaining ethanol. The resulting gel was then lyophilized to a constant weight. The resulting powder was ground. 13.7 g of white powder were obtained (polymer 4).

d) Polymer 5

A silica polymer was prepared by sol-gel pathway from tetraethyl orthosilicate to obtain a xerogel with the general formula SiO₂ according to the synthesis described in the publication, Sasaki, D. Y.; Alam, T. M. American Chemical Society 2000, 12, 1400-1407. In this case, the acid is neutralized to 91%.

30.5 g tetraethyl orthosilicate were mixed with 30.6 g ethanol, 42 g deionized water and 1 ml of hydrochloric acid solution 0.1M. It was stirred for 10 minutes at room temperature and then for 1.5 hours at 60° C. Then 0,91 ml of aqueous solution ammonium hydroxide 0.1M was added to the resulting solution. The mixture was put to incubate without stirring for 24 hours at 50° C. A gel was obtained that was then washed twice with 100 ml ethanol. The excess liquid was removed by filtration after each washing. The gel was then washed twice with 100 ml deionized water, the excess liquid being removed by ultra-centrifugation (3200 rpm for 10 minutes) after each washing. The gel was then lyophilized to a constant weight. The resulting powder was ground. 8.2 g of white powder were obtained (polymer 5).

f) Polymer 6

A silica polymer was prepared by sol-gel pathway from tetraethyl orthosilicate to obtain a xerogel with the general formula SiO₂, without acid neutralization.

4740 g tetraethyl orthosilicate were mixed with 1200 g ethanol, 2520 g deionized water and 60 ml of hydrochloric acid solution 0.1M. It was stirred for 10 minutes at room temperature. The mixture was put to incubate without stirring for 12 hours at 75° C. A gel was obtained that was then gently heated to 40° C. in a vacuum (15 mm Hg) to remove practically all the remaining ethanol. The resulting gel was then lyophilized to a constant weight. The resulting powder was ground. 1596 g of white powder were obtained (polymer 6).
3) Measurement of the RMN ²⁹Si spectra

The RMN ²⁹Si spectra of polymers 1, 4 and 6 were measured. For comparative purposes, the RMN ²⁹Si spectrum was also measured for amorphous colloidal silica Ludox™ PGE at 30% in water, marketed by Grace Davison. The measuring method given in the description was used. As reference tetramethylsilane was used to calculate the displacements.

The four silica samples were characterized by 3 peaks at −108/−110, −101 and −92 ppm assigned to the units Q₄, Q₃ and Q₂ respectively.

The quantitative analysis of the RMN ²⁹Si spectra is summarized in Table I, as well as the network's degree of condensation corresponding to the condensation efficiency (% age of ethoxy groups that led to the formation of an oxo bridge).

TABLE I

| | Q₂ | Q₃ | Q₄ | |
|---|---|---|---|---|
| | δ(ppm) | δ(ppm) | δ(ppm) | Degree of |
| Sample | (%) | (%) | (%) | Cond. (%) |
| Silica | — | −101.3 | −111.3 | 96.1 |
| LUDOX ™ | | (15.6) | (84.4) | |
| PGE | | | | |
| Polymer 1 | −92.1 | −100.6 | −109.8 | 89.1 |
| | (6.8) | (30.0) | (63.2) | |
| Polymer 4 | −92.1 | −100.4 | −109.00 | 85.8 |
| | (8.7) | (39.4) | (51.9) | |
| Polymer 6 | −92.1 | −100.3 | −108.9 | 84.8 |
| | (10.9) | (39.0) | (50.1) | |

Polymers 4 and 6 have a degree of condensation less than that of LUDOX ™ PGE silica and polymer 1, and are selected to be used in the present invention.

4) Preparation of coating compositions constituting an ink-receiving layer coated on a support

As hydrosoluble binder, polyvinyl alcohol was used (Gohsenol™ GH23 marketed by Nippon Gohsei) diluted to 9% by weight in osmosed water.

The compositions comprised, as receiving agent, the silica polymers prepared according to paragraphs 1 and 2 as well as the Ondeo Nalco®2329 silica marketed by Ondeo Nalco Corporation (amorphous colloidal silica, dispersion at 40%) and Ludox™ PGE silica.

All the coating compositions comprising silica polymers 1 to 6 were obtained by mixing:
3 g receiving agent (dry matter)
4 g polyvinyl alcohol at 9%
15 g deionized water

The coating composition comprising Ludox™ PGE silica was obtained by mixing:
10 g receiving agent (30%)
4 g polyvinyl alcohol at 9%
8 g deionized water

The coating composition comprising Nalco®2329 silica was obtained by mixing:

7.5 g receiving agent (40%)
4 g polyvinyl alcohol at 9%
10.5 g deionized water

The mixtures were homogenized using a roller stirrer and five 10-mm diameter glass beads for 12 hours.
5) Preparation of inkjet recording elements

To do this, a Resin Coated Paper type support was placed on a coating machine, first coated with a very thin gelatin layer, and held on the coating machine by vacuum. This support was coated with a composition as prepared according to paragraph 4 using a blade. Then, it was left to dry in the atmosphere (21° C.) for 12 hours to obtain a coating density between 15 g/m² and 20 g/m².

The resulting recording elements correspond to the examples given in table II below specifying the receiving agent used in the ink-receiving layer:

TABLE II

| | Receiving agent in the |
|---|---|
| Recording element | ink-receiving layer |
| Ex. 1 (comp.) | Polymer 1 |
| Ex. 2 (inv.) | Polymer 2 |
| Ex. 3 (inv.) | Polymer 3 |
| Ex. 4 (inv.) | Polymer 4 |
| Ex. 5 (inv.) | Polymer 5 |
| Ex. 6 (inv.) | Polymer 6 |
| Ex. 7 (comp.) | Ludox ™ PGE |
| Ex. 8 (comp.) | Nalco ®2329 |

4) Evaluation of dye keeping properties in time

To evaluate dye keeping in time, a dye fading test by exposure to ozone was performed for each resulting recording element. To do this, targets, comprising four colors (black, yellow, cyan and magenta) were printed on each recording element using a KODAK PPM 200 printer and related ink. The targets were analyzed using a GretagMacbeth Spectrolino spectrophotometer that measured the intensity of the various colors. Then the recording elements were placed in the dark in a room with controlled ozone atmosphere (60 ppb) for three weeks. Each week, any degradation of the color density was monitored using the spectrophotometer.

Also, for certain resulting recording elements, a dye fading test was carried out by exposure to light of 50 Klux for 2 weeks. To do this, targets comprising the four colors, black, yellow, cyan and magenta were printed on the resulting recording elements using a KODAK PPM 200 and related ink or a Hewlett Packard HP 5550 printer and related ink. Then the printed targets were placed under a sheet of Plexiglas® 6 mm thick and totally transparent to the emission spectra of the neon tubes used (Osram Lumilux® FQ 80 W/840 Cool White), in order to minimize atmospheric oxidation phenomena. Any deterioration of the color density was measured using the densitometer after 2 weeks.

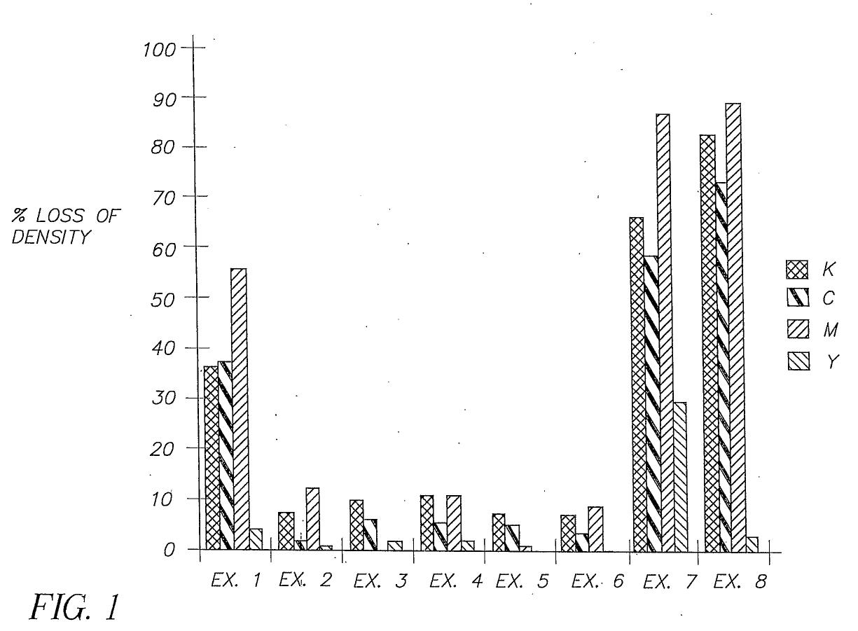

FIG. 1 represents the percentage of density loss observed for the original density of 0.5 for the four colors of the target after three weeks for examples 1 to 8 printed using the Kodak PPM 200 printer and exposed to ozone. Letters K, C, M and Y represent the colors black, cyan, magenta and yellow respectively.

It may be noted that the inkjet recording elements according to the invention (Examples 2 to 6) comprising an amorphous silica polymer having a degree of condensation between 75% and 88% have greater stability to ozone and thus better dye keeping than the comparative elements.

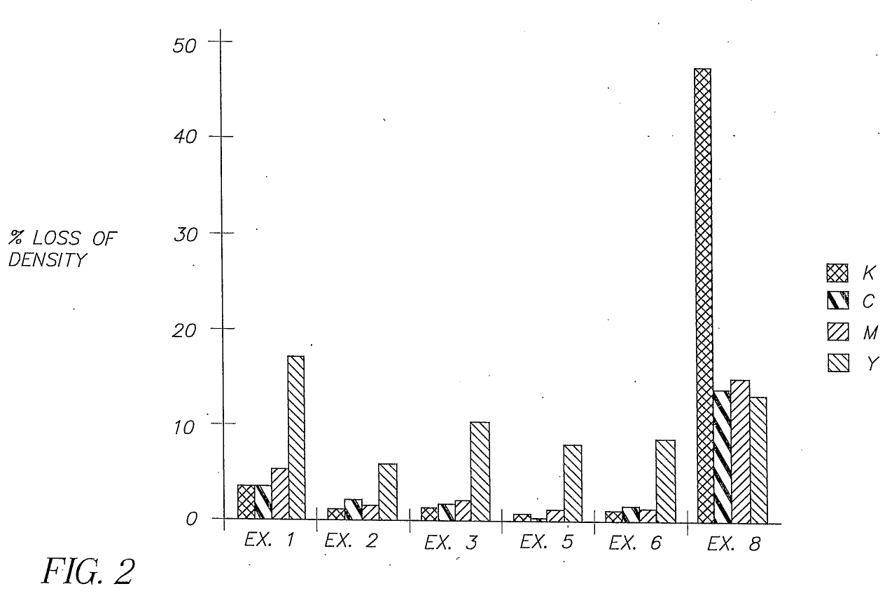

FIG. 2 represents the percentage of density loss observed for the original density of 0.5 for the four colors of the target after two weeks for examples 1, 2, 3, 5, 6 and 8 printed using the HP 5550 printer and exposed to light.

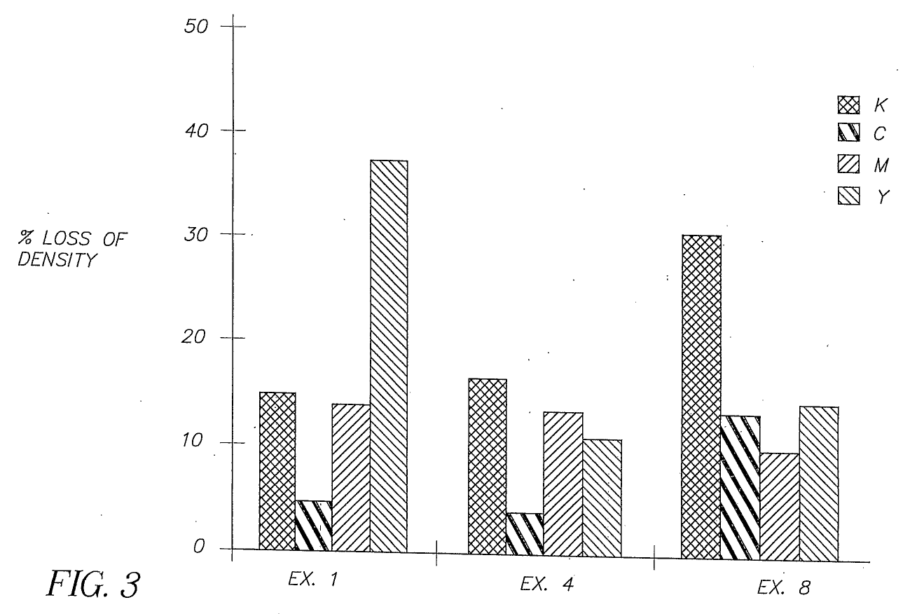

FIG. 3 represents the percentage of density loss observed for the original density of 0.5 for the four colors of the target after two weeks for examples 1, 4, and 8 printed using the Kodak PPM 200 printer and exposed to light.

It may be noted that the inkjet recording elements according to the invention comprising an amorphous silica polymer having a degree of condensation between 75% and 88% have greater stability to light and thus better dye keeping than the comparative elements. In particular, the yellow color printed on the recording elements according to the invention is much more stable to light than when it is printed on the comparative elements.

1. An inkjet recording element, comprising a support and at least one ink-receiving layer, wherein said ink-receiving layer comprises at least one amorphous silica polymer having a degree of condensation between 75% and 88%.

2. The recording element according to claim 1, wherein said amorphous silica polymer is obtained by sol-gel pathway in acid catalytic conditions from silicon alkoxides.

3. The recording element according to claim 2, wherein the silicon alkoxide is tetraethyl orthosilicate.

4. The recording element according to claim 2, wherein the acid used for the acid catalysis comprises an acid selected from the group consisting of hydrochloric acid, perchlorhydric acid and nitric acid.

5. The recording element according to claim 1, wherein said amorphous silica polymer has a degree of condensation between 75% and 87%.

6. The recording element according to claim 5, wherein said amorphous silica polymer has a degree of condensation between 75% and 86%.

7. The recording element according to claim 6, wherein said amorphous silica polymer has a degree of condensation between 80% and 86%.

8. The recording element according to claim 7, wherein said amorphous silica polymer has a degree of condensation between 84% and 86%.

9. The recording element according to claim 1, wherein the ink-receiving layer comprises between 5% and 95% by weight of said amorphous silica polymer compared with the total weight of the dry receiving layer.

10. The recording element according to claim 1, wherein the ink-receiving layer comprises a hydrosoluble binder.

11. The recording element according to claim 10, wherein the hydrosoluble binder is gelatin or polyvinyl alcohol.

12. The use of at least one amorphous silica polymer having a degree of condensation between 75% and 88% as receiving agent in an ink-receiving layer of an inkjet recording element.
